(19) United States
(12) Patent Application Publication
(10) Pub. No.: US 2026/0063492 A1
(43) Pub. Date: Mar. 5, 2026

(54) OIL-LESS PRESSURE SENSOR WITH OVERPRESSURE LIMIT

(71) Applicant: Weed Instrument Company, Inc., Round Rock (US)

(72) Inventors: Taylor Michael Campbell, Austin, TX (US); Mark Alan McCray, Austin, TX (US)

(73) Assignee: Weed Instrument Company, Inc., Round Rock (US)

(21) Appl. No.: 18/980,900

(22) Filed: Dec. 13, 2024

Related U.S. Application Data
(60) Provisional application No. 63/687,417, filed on Aug. 27, 2024.

(51) Int. Cl. G01L 19/06; G01L 13/06

(52) U.S. Cl. CPC G01L 19/0618; G01L 13/06; G01L 19/0645

(57) ABSTRACT

A pressure sensor includes a housing having an internal cavity, a pressure port, and a hole through which pressure is communicated between the pressure port and the internal cavity. A bellows within the cavity is configured to expand and contract responsive to changes in pressure at the pressure port. The pressure sensor additionally includes a load cell configured to generate signal indicating a magnitude of a pressure applied to the bellows, a moveable stop engagement member mechanically coupled to the bellows, and a mechanical overpressure stop that limits expansion of the bellows by mechanically engaging the moveable stop engagement member.

### BACKGROUND OF THE INVENTION

The present disclosure relates to the measurement of pressure and, more particularly, the measurement of differential pressure of fluids.

Conventional differential pressure sensors typically internally utilize silicone oil or similar incompressible liquid fluid for process isolation and overpressure protection. As a consequence of the use of an incompressible liquid fluid, such as silicone oil, the maximum operating temperature of conventional different pressure sensors is limited by the material properties of the incompressible liquid fluid.

### SUMMARY OF THE INVENTION

The present application appreciates that it would be useful and desirable to provide a differential pressure sensor that is not limited in application by the material properties of an incompressible liquid fluid.

In view of the foregoing, an oil-less pressure sensor suitable for sensing differential pressures in a wide variety of operating environments is disclosed. In at least some embodiments, the pressure sensor includes a load cell, a mechanical overpressure stop, and one or more sealed bellows mechanically coupled to the load cell such that differential pressure changes across the load cell are detected by the load cell.

In some embodiments, a pressure sensor includes a housing having an internal cavity, a pressure port, and a hole through which pressure is communicated between the pressure port and the internal cavity. A bellows within the cavity is configured to expand and contract responsive to changes in pressure at the pressure port. The pressure sensor additionally includes a load cell configured to generate signal indicating a magnitude of a pressure applied to the bellows, a moveable stop engagement member mechanically coupled to the bellows, and a mechanical overpressure stop that limits expansion of the bellows by mechanically engaging the moveable stop engagement member.

In at least some embodiments, the pressure sensor is configured such that, if pressure increases above an overpressure set point, at least one bellows directly or indirectly mechanically engages the overpressure stop and no additional force is applied to the load cell, preventing damage to the load cell by application of force resulting from overpressure. The pressure sensor is configured such that, if the pressure drops below the overpressure set point, the pressure sensor resumes normal operation and is again able to detect changes in pressure.

In at least some embodiments, the load cell signals, indicates, and/or reports a pressure measurement or magnitude.

In at least some embodiments, the pressure sensor is oil-less and therefore does not utilize or require an internal incompressible fluid. As a result, the pressure sensor can be employed in operating environments characterized by extremely high temperatures and/or radiation levels.

In some embodiments, the overpressure set point of the pressure sensor is field-adjustable and, in some embodiments, can be adjusted while the pressure sensor is installed and pressure is applied.

In some embodiments, the mechanical overpressure stop comprises a set screw.

A pressure sensor as disclosed herein is useful in a variety of applications, including conventional nuclear power reactors, Generation IV advanced nuclear power reactors, space applications, and other challenging operating environments in which the thermal and rheological properties of incompressible liquid fill fluids and/or presence of ionizing radiation prevented implementation of conventional pressure sensors.

### BRIEF DESCRIPTION OF THE DRAWINGS

FIG. 1 is a section view of an exemplary pressure sensor in accordance with one or more embodiments;

FIGS. 2-4 are section views of an exemplary pressure sensor illustrating operation of the pressure sensor without an overpressure stop being set;

FIG. 5 is a section view of an exemplary pressure sensor depicting the overpressure stop limiting force applied to the load cell; and

FIGS. 6-7 are section views of an exemplary pressure sensor illustrating operation of the pressure sensor in a high-static differential pressure application.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

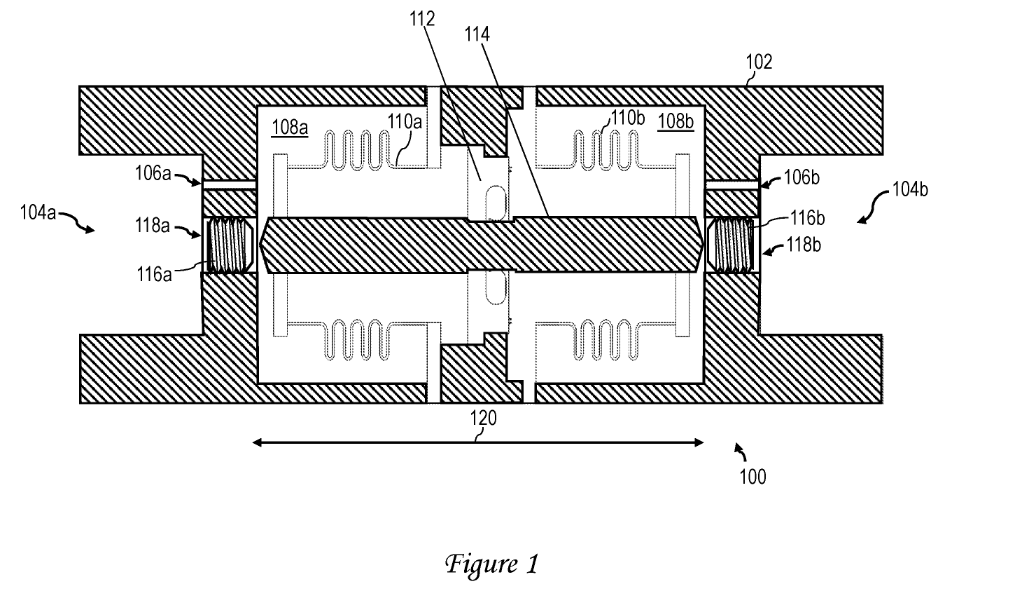

Referring now to FIG. 1, there is illustrated an exemplary pressure sensor 100 in accordance with one or more embodiments. In this example, pressure sensor 100 includes a housing 102, which is preferably formed of a durable material. In some implementations, housing 102 is selected to be a high strength, corrosion resistant metal alloy, such as stainless steel.

Housing 102 includes first and second pressure ports 104a, 104b, which can be exposed to or coupled to respective enclosures (e.g., pressure vessels and/or fluid conduits) having different pressures. In some embodiments, pressure ports 104a, 104b may include or be further coupled to suitable fittings for pressure-tight communication with the pressure sources, as is known in the art. Housing 102 additionally includes two internal cavities 108a, 108b, each of which is in fluid communication with a respective one of pressure ports 104a, 104b via a respective vent hole 106a, 106b formed through housing 102. It should be noted that, in preferred embodiments, internal cavities of bellows 110a and 110b are oil-less and contain no (i.e., are void of) incompressible liquid fluid.

One or more bellows is/are disposed within one or more of cavities 108a, 108b of housing 102. For example, in the illustrated embodiment, each of cavities 108a, 108b includes a respective bellows 110a, 110b. In other embodiments, housing 102 may contain a single bellows disposed in one of cavities 108a, 108b. In at least some embodiments, bellows 110 can be formed of metal. In at least some embodiments, bellows 110a, 110b can have equal internal pressures. In at least some embodiments, a bellows 110 can be vacuum-filled, that is, can have an internal pressure that is significantly lower than the pressure sources to which pressure ports 104 are exposed in typical operating environments. Each bellows 110 contracts along line 120 if exposed to a relatively higher pressure source and expands along line 120 if exposed to a relatively lower pressure source. Bellows 110 is/are further coupled to a stop engagement member, such as a rod 114 that moves linearly along line 120 as bellows 110 expand and contract. Rod 114, which can be formed of a durable metal (e.g., stainless steel), converts the pressures acting on bellows 110 into a linearly applied force.

Housing 102 of pressure sensor 100 further includes a load cell 112, which, in the exemplary embodiment, is disposed between cavities 108a, 108b. Load cell 112, which can be implemented, for example, with a strain gauge, is mechanically engaged by rod 114 and thus acted upon by the linear force applied by rod 114. Based on the applied force, load cell 112 generates an electrical signal representative of the pressure differential, if any, between cavities 108a, 108b. This electrical signal can be converted by an unillustrated display, readout, alarm device or other unit in signal communication with load cell 112 into an indication of the pressure differential.

In at least some embodiments, pressure sensor 100 further includes at least one mechanical overpressure stop. In at least some embodiments, a mechanical overpressure stop is configured to be field-adjustable. In the depicted example, the mechanical overpressure stop(s) is/are implemented by one or more set screws 116a, 116b threadedly received and selectively rotatable within a respective one of bores 118a, 118b. As will be appreciated, depending on the expected range of pressures in a given application environment, set screws 116a, 116b can be selectively manually adjusted (i.e., rotated within bores 118a, 118b) to limit linear displacement of rod 114 along line 120 in neither direction, in one direction, or in both directions. Limiting the linear displacement of rod 114 by set screws 116 limits the force applied to load cell 112 by rod 114 and thus reduces the likelihood of pressure-induced damage to load cell 112. Those skilled in the art will appreciate that although set screws 116a, 116b are utilized to implement mechanical overpressure stops in pressure sensor 100 of FIG. 1, in other embodiments, other mechanical overpressure stops (including adjustable mechanical stops) can alternatively or additionally be employed.

In the depicted arrangement, a set screw 116 can be adjusted (or set) while pressure is applied to the pressure port for which it determines a displacement limit. Thus, for example, a driver inserted in pressure port 104a can be utilized to adjust set screw 116a to limit the linear displacement of rod 114 caused by pressure on pressure port 104b. Similarly, set screw 116b can be set utilizing a driver inserted in pressure port 104b in order to limit the linear displacement of rod 114 caused by pressure on pressure port 104a. While this design does potentially requires a pressure input to be disconnected from the opposing pressure port for tuning, pressure inputs, if any, can be reconnected to pressure ports 104a, 104b once set screws 116a, 116b are adjusted.

In other embodiments, set screws 116a, 116b can be implemented external to both pressure ports’ process fluid and pressure. As one example, a secondary bellows system can be configured to function as a pressure boundary between the process pressure and the set screw. The benefit of such a configuration would be that no process inputs would need to be removed while setting the overpressure protection system, and the overpressure protection system can be tuned without disconnection of pressure sources from pressure ports 104.

In some use cases, one of pressure ports 104a, 104b is connected to a negative pressure input, and the other of pressure ports 104a104b is connected to a positive pressure input. In other use cases, both of pressure ports 104a, 104b are connected to either negative pressure inputs or positive pressure inputs. In all of these use cases, load cell 112 detects and generates a signal representative of a magnitude of a differential pressure. In another example, pressure sensor 102 includes only a single vacuum-filled bellows 110, and load cell 112 detects and generates a signal representative of a magnitude of an absolute pressure.

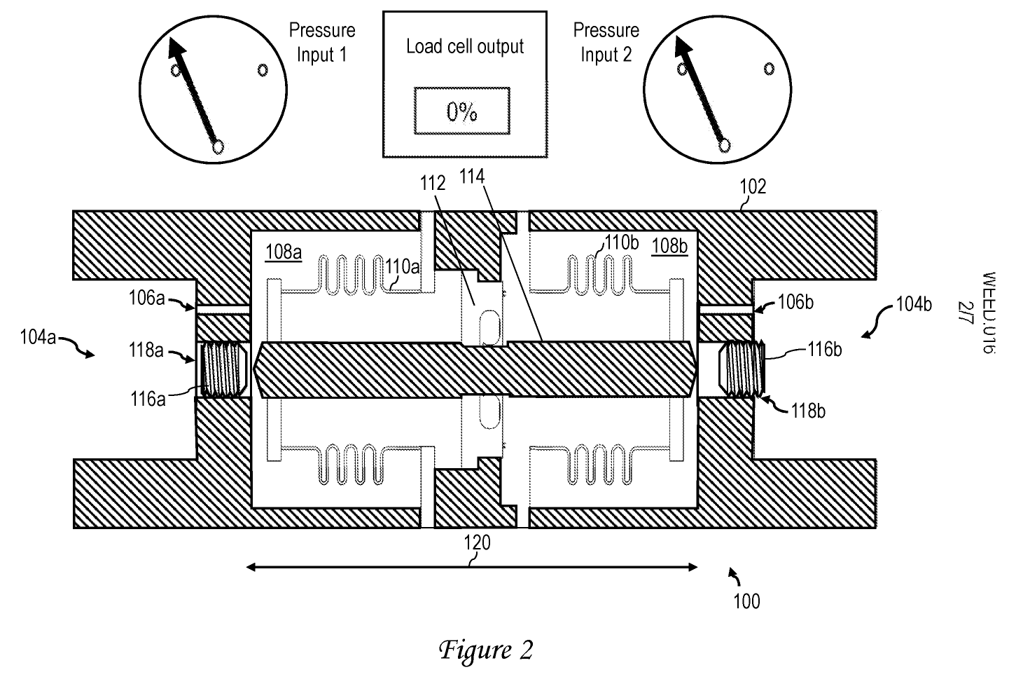

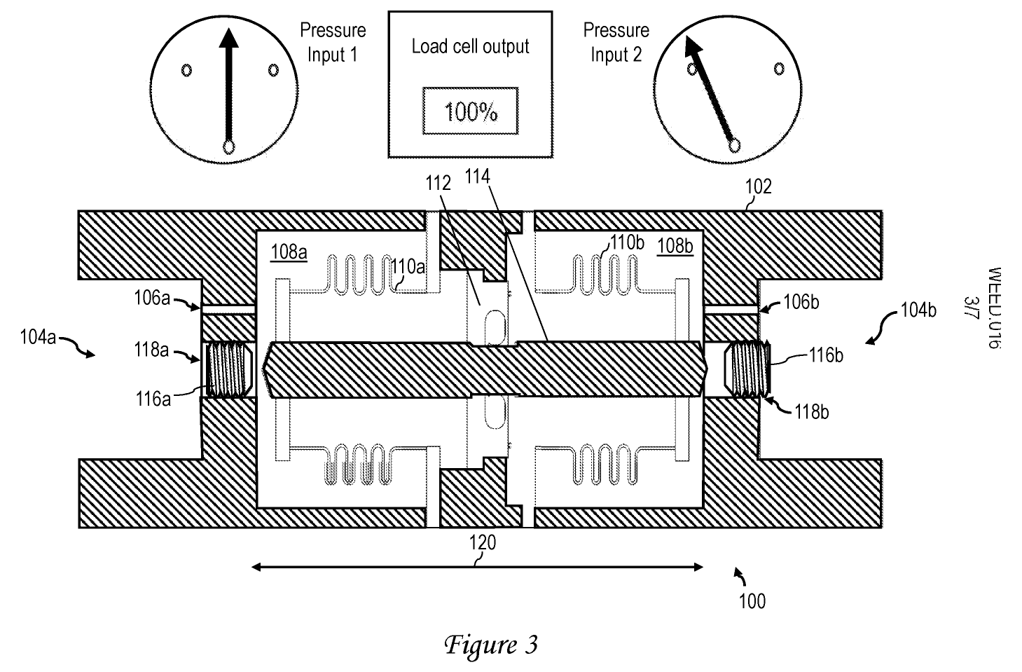

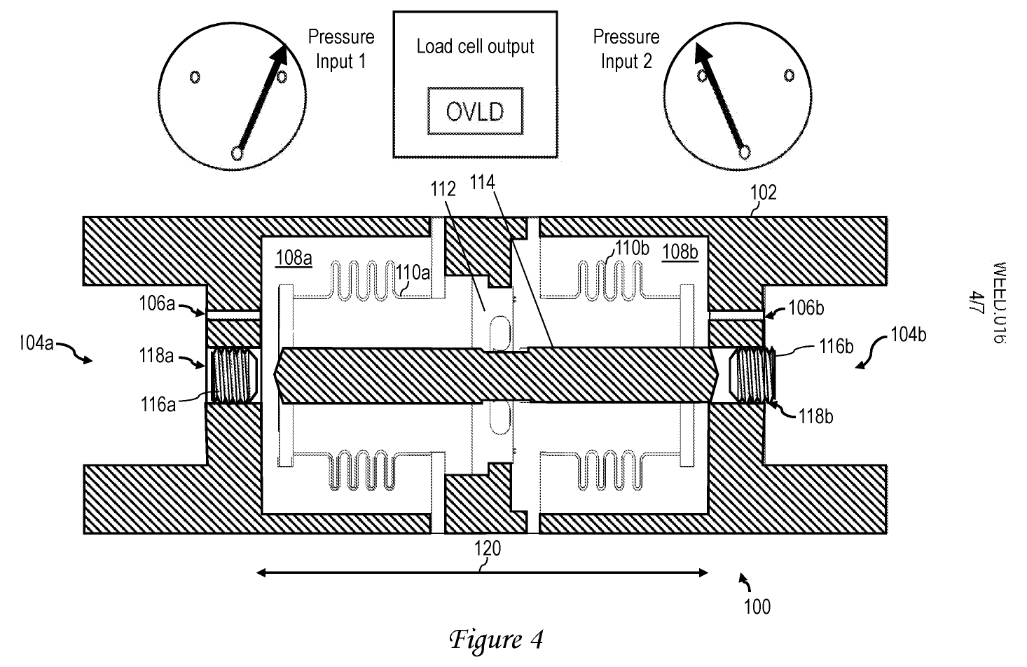

Referring now to FIGS. 2-4, there are depicted section views of exemplary pressure sensor 100 illustrating operation of pressure sensor 100 without an overpressure stop being set. In the example of FIG. 2, pressure is applied to neither pressure port 104a nor pressure port 104b, and load cell 112 generates a signal indicative of the presence of no pressure differential between pressure ports 104a, 104b. As indicated, this pressure differential can be denominated as a percentage (e.g., 0%) or can alternatively or additionally be indicated as an absolute value. FIG. 3 illustrates a second example in which pressure is applied to pressure port 104a, no pressure is applied to pressure port 104b, and load cell 112 outputs an electrical signal indicative of a pressure differential between pressure ports 104a, 104b equal to 100% of the pressure sensor’s upper range limit. FIG. 4 depicts another example in which pressure greater than the pressure sensor’s upper range limit is applied to pressure port 104a, no pressure is applied to pressure port 104b, and load cell 112 outputs an electrical signal indicative of an overpressure (overload) condition. In this case, load cell 112 may be vulnerable to damage due to no overpressure stop being engaged.

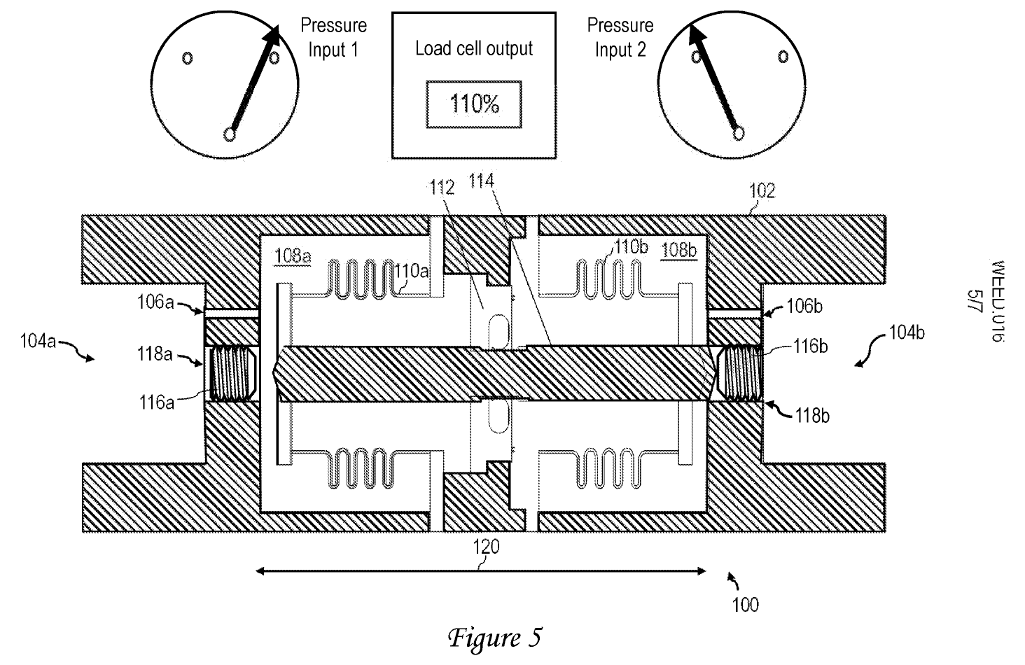

With reference now to FIG. 5, there is illustrated a section view of exemplary pressure sensor 100 depicting an overpressure stop limiting force applied to load cell 112. In this case, the pressure applied to pressure port 104a is 110% of the pressure sensor’s upper range limit relative to the ambient pressure at pressure port 104b. Despite the high pressure applied to pressure port 104a, load cell 112 is protected from potential damage by mechanical engagement of rod 114 with set screw 116b, which limits the range of linear displacement of rod 114 towards pressure port 104b.

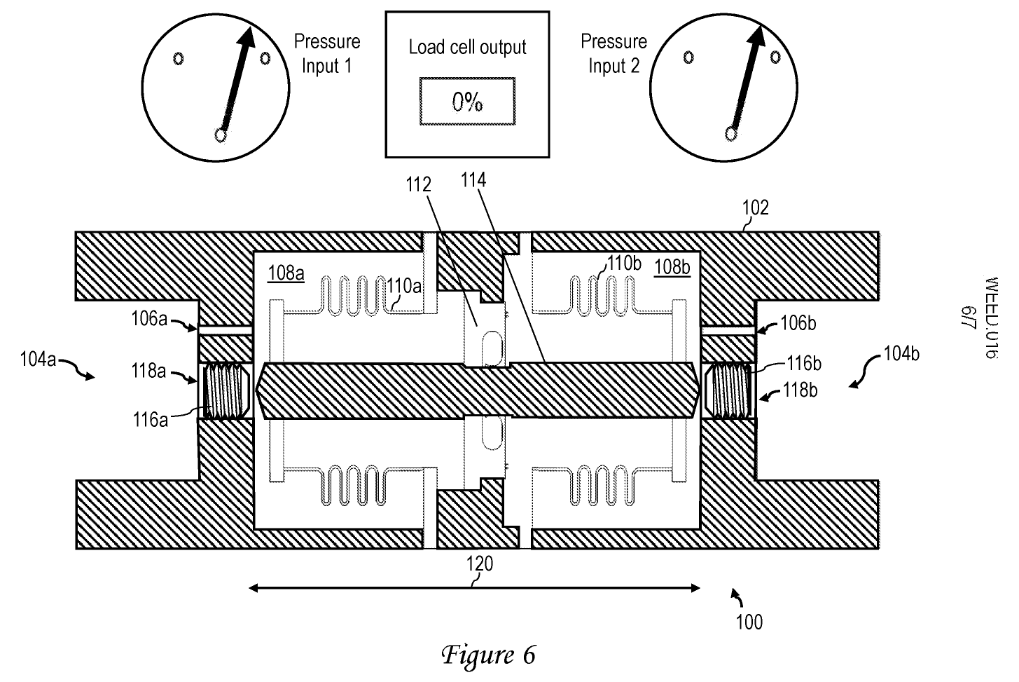

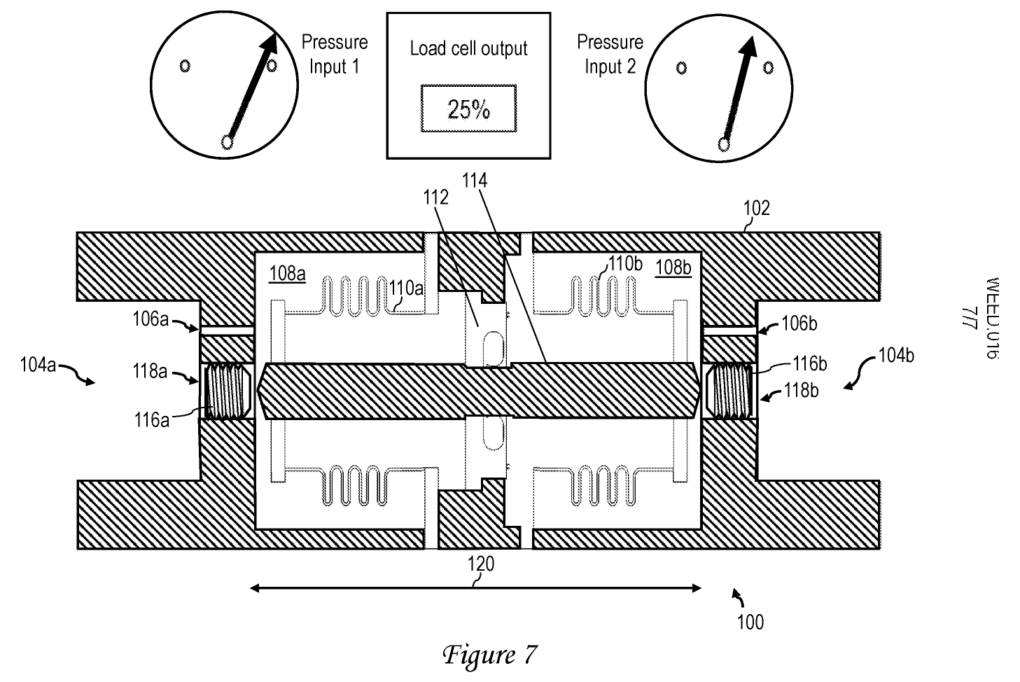

FIGS. 6-7 provide additional section views of exemplary pressure sensor 100, which depict operation of pressure sensor 100 in a high static differential pressure application. Specifically, FIG. 6 depicts a use case in which equal high pressure is applied to both of pressure ports 104a, 104b, and load cell 112 generates a signal indicative of an absence of pressure differential between pressure ports 104a, 104b. FIG. 7 shows an additional use case in which unequal high pressure is applied to pressure ports 104a, 104b, and load cell 112 generates a signal indicative of a relatively low pressure differential (e.g., 25%) between pressure ports 104a, 104b.

As has been described, in at least one embodiment, a pressure sensor includes a housing having an internal cavity, a pressure port, and a hole through which pressure is communicated between the pressure port and the internal cavity. A bellows within the cavity is configured to expand and contract responsive to changes in pressure at the pressure port. The pressure sensor additionally includes a load cell configured to generate signal indicating a magnitude of a pressure applied to the bellows, a moveable stop engagement member mechanically coupled to the bellows, and a mechanical overpressure stop that limits expansion of the bellows by mechanically engaging the moveable stop engagement member.

While the present invention has been particularly shown as described with reference to one or more preferred embodiments, it will be understood by those skilled in the art that various changes in form and detail may be made therein without departing from the spirit and scope of the invention.

The following definitions are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, system or apparatus that comprises a list of elements is not necessarily limited to only those elements but can include other elements not expressly listed or inherent to such composition, mixture, process, method, article, system or apparatus.

Additionally, the term “exemplary” is used herein to mean “serving as one example, instance or illustration.” Any embodiment or design described herein as “exemplary” is not necessarily to be construed as preferred or advantageous over other embodiments or designs. The terms “at least one” and “one or more” shall be understood to include any integer number greater than or equal to one, and the term “plurality” shall be understood to include any integer number greater than or equal to two. The term “coupled” shall include both indirect connection and a direct connection, unless specified otherwise in a particular case. The terms “about,” “substantially,” “approximately,” and variations thereof, are intended to include the degree of error associated with measurement of the particular quantity based upon the equipment available at the time of filing the application. For example, “about” can include a range of ±10% or ±5%, or ±2% of a given value.

The figures described herein and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. For the sake of brevity, conventional techniques related to making and using aspects of the invention(s) may or may not be described in detail herein, and many conventional implementation details are only mentioned briefly or are omitted entirely. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A pressure sensor, comprising:
a housing having a pressure port, an internal cavity, and a hole through which pressure is communicated between the pressure port and the internal cavity;
a bellows, within the cavity, that is configured to expand and contract responsive to changes in pressure at the pressure port;
a load cell configured to generate a signal indicating a magnitude of a pressure applied to the bellows;
a moveable stop engagement member mechanically coupled to the bellows; and
a mechanical overpressure stop that limits expansion of the bellows by mechanically engaging the moveable stop engagement member.

2. The pressure sensor of claim 1, further comprising:
a plurality of pressure ports including the pressure port.

3. The pressure sensor of claim 1, wherein the pressure sensor is a differential pressure sensor.

4. The pressure sensor of claim 3, wherein:
the internal cavity is a first internal cavity, the bellows is a first bellows, the hole is a first hole, and the pressure port is a first pressure port;
the housing includes:
a second internal cavity in which a second bellows is disposed;
a second pressure port in pressure communication with the second internal cavity via a second hole; and
the load cell is interposed between the first and second bellows.

5. The pressure sensor of claim 1, wherein the mechanical overpressure stop is adjustable.

6. The pressure sensor of claim 1, wherein the mechanical overpressure stop is adjustable while pressure is applied to the pressure port.

7. The pressure sensor of claim 1, wherein the mechanical overpressure stop comprises a set screw.

8. The pressure sensor of claim 1, wherein the movable stop engagement member is a rod having a linear path of travel.

9. The pressure sensor of claim 1, wherein the load cell includes a strain gauge.

10. The pressure sensor of claim 1, wherein the housing is void of any incompressible liquid fluid.

11. The pressure sensor of claim 1, wherein the moveable stop engagement member mechanically engages the load cell.

12. A pressure-sensing method, comprising:
providing a pressure sensor, including:
a housing having a pressure port, an internal cavity, and a hole through which pressure is communicated between the pressure port and the internal cavity;
a bellows, within the cavity, that is configured to expand and contract responsive to changes in pressure at the pressure port;
a load cell configured to generate a signal indicating a magnitude of a pressure applied to the bellows;
a moveable stop engagement member mechanically coupled to the bellows; and
a mechanical overpressure stop that limits expansion of the bellows by mechanically engaging the moveable stop engagement member; and
outputting, by the load cell, the signal.

13. A differential pressure sensor, comprising:
a housing having first and second pressure ports, first and second internal cavities, a first hole through which pressure is communicated between the first pressure port and the first internal cavity, and a second hole through which pressure is communicated between the second pressure port and the second internal cavity;
a first bellows, within the first cavity, that is configured to expand and contract responsive to changes in pressure at the first pressure port;
a second bellows, within the second cavity, that is configured to expand and contract responsive to changes in pressure at the second pressure port;
a load cell interposed between the first and second bellows, wherein the load cell is configured to generate a signal indicating a magnitude of a differential pressure applied to the first and second bellows;
a moveable stop engagement member mechanically coupled to at least one bellows among the first and second bellows; and
a mechanical overpressure stop that limits expansion of the at least one bellows by mechanically engaging the moveable stop engagement member.

14. The pressure sensor of claim 13, wherein the mechanical overpressure stop is adjustable.

15. The pressure sensor of claim 14, wherein the mechanical overpressure stop is adjustable while pressure is applied to the first pressure port.

16. The pressure sensor of claim 13, wherein the mechanical overpressure stop comprises a set screw.

17. The pressure sensor of claim 13, wherein the movable stop engagement member is a rod having a linear path of travel.

18. The pressure sensor of claim 13, wherein the load cell includes a strain gauge.

19. The pressure sensor of claim 13, wherein the housing is void of any incompressible liquid fluid.

20. The pressure sensor of claim 13, wherein the moveable stop engagement member mechanically engages the load cell.
